(19) United States
(12) Patent Application Publication
(10) Pub. No.: US 2019/0041939 A1
(43) Pub. Date: Feb. 7, 2019

(54) POWER MANAGEMENT

(71) Applicant: HEWLETT-PACKARD DEVELOPMENT COMPANY, L.P., Houston, TX (US)

(72) Inventor: David E. SMITH, Vancouver, WA (US)

(73) Assignee: HEWLETT-PACKARD DEVELOPMENT COMPANY, L.P., Houston, TX (US)

(21) Appl. No.: 16/074,832

(22) PCT Filed: Oct. 26, 2016
(86) PCT No.: PCT/US2016/058889

§ 371 Date: Aug. 2, 2018

(51) Int. Cl. G06F 1/30; G05F 1/12

(52) U.S. Cl. CPC G06F 1/305; G05F 1/12

(57) ABSTRACT

In an example implementation, a method of power management, includes gradually increasing a compensation load in parallel with the device load to increase AC mains current up to a current set point prior to activating a device load. The method includes activating the device load, and upon sensing activation of the device load, decreasing the compensation load to maintain the mains current at the current set point.

### BACKGROUND

The main power supply in most homes and businesses is accessed by plugging a device into a wall outlet. This power supply can be referred to in a variety of different ways including, for example, as wall power, grid power, household electricity, line power, AC power, AC mains, and so on. Electrical equipment and/or devices plugged into the “AC mains” can have varying power consumption profiles. While different devices can pull greater or lesser amounts of current, some devices can have more complicated power consumption cycles that can cause fluctuations in the amount of current being drawn from the AC mains. Fluctuations in current through the AC mains circuitry can cause the voltage to change at the same rate as the fluctuating current. Changes in the voltage can cause the dimming or flickering of lights plugged into the AC mains, referred to as flicker. Such voltage changes on the AC mains can be problematic for sensitive electronic equipment and for people who have photosensitive eyes and other health issues.

### BRIEF DESCRIPTION OF THE DRAWINGS

Examples will now be described with reference to the accompanying drawings, in which:

FIG. 1 shows a block diagram of an example power management system to reduce voltage fluctuations in an AC mains power supply;

FIG. 2 shows a block diagram of an example power management system and a 3D printing device that implements a cyclical device load;

FIG. 3 shows a circuit diagram of an example control loop circuit;

FIG. 4 shows example plots representing the behavior of AC mains current, a device load, and a compensation load, during a time period encompassing part of a print process cycle;

FIG. 5 shows a circuit diagram of an example control loop circuit with additional details of a voltage error amplifier; and

FIGS. 6 and 7 are flow diagrams showing example methods of power management.

Throughout the drawings, identical reference numbers designate similar, but not necessarily identical, elements.

### DETAILED DESCRIPTION

International electro-technical (IEC) standards specify limits on the level of voltage change, or flicker, that can be caused by an electrical appliance/device operating on the AC mains power supply. Flicker is caused by load changes within a device that occur in a mostly step-wise fashion over short time periods. Products are tested to ensure compliance with the standards, and many international markets that recognize these requirements, such as the European Union, the United Kingdom and other countries, prohibit the shipment and sale of products that do not meet the IEC standards. A flicker meter, as defined by an IEC standard, can be used to determine a short term flicker “perceptibility” value, referred to as Pst. Several Pst values determined over a longer time period can be used to determine a long term flicker “perceptibility” value, referred to as Plt. The relevant IEC flicker standard presently limits the value of Pst to 1.0 over an observation period of 10 minutes, and the value of Plt to 0.65 over an observation period of 2 hours.

Three-dimensional (3D) printing devices are one example of an electrical appliance that can utilize large amounts of electrical power in an uneven and repeatable (i.e., cyclical) manner that can cause fluctuations in the AC mains power supply. In some 3D printing devices, for example, increased electrical power can be used to generate heat in a cyclical process that can fuse plastic and other materials into layers of a 3D part, one layer at a time. Such devices can vary their operating power instantaneously by activating and deactivating large loads, such as heating lamps, to achieve high part quality and throughput. In some examples, the resulting fluctuations in AC mains power caused by such devices can conflict with the international regulatory standards.

In some examples of product development, consideration for how a device can meet the IEC standards for AC mains voltage fluctuation is left to the end of the product development cycle. The result can lead to inadequate solutions and costly delays with respect the introduction of products into some international markets. Some solutions for meeting the IEC standards have included slowing down power fluctuations within a device to meet regulatory requirements, balancing the switching of large loads to minimize overall AC mains power fluctuations, and adding hardware to buffer the AC mains from the device power fluctuations. In some examples, however, these types of solutions can have certain drawbacks. Slowing down power fluctuations, for example, can cause poor performance in devices such as 3D printers, by reducing 3D part throughput and quality. Balancing the switching of large loads in a device can involve the use of complex firmware synchronization of loads, and a lack of flexibility to adapt to changes in device power requirements to maintain quality. Adding hardware to buffer the AC mains from device power fluctuations can result in excessive cost and complexity in a device.

Accordingly, examples of a power management system and methods are described herein that compensate for instantaneous power fluctuations in devices operating from an AC mains power supply. The power management system enables devices such as 3D printers to meet IEC “flicker” regulatory standards while not interfering with the device operations that can involve the activation and deactivation of large loads that can cause such fluctuations in power.

A controller of a power management system can anticipate the moment a large device load will be activated. Prior to activating the device load, the controller can initiate and manage a gradual ramping up of AC mains current (e.g., over several seconds) through a compensation load that is in parallel with the device load. Upon activation of the device load, a control loop of the power management system senses an abrupt increase in the AC mains current and counters this increase by turning off the compensation load instantly (e.g., over a time period on the order of microseconds), which reroutes the ramped up AC mains current from the compensation load to the parallel device load. The virtually instantaneous manner in which the compensation load is turned off and “replaced” by the device load helps to avoid a fluctuation in the AC mains current.

Upon deactivation of the device load, the control loop senses an abrupt decrease in the AC mains current and counters this decrease by turning on the compensation load instantly (e.g., over a time period on the order of microseconds), which reroutes the ramped up AC mains current from the deactivated device load back to the parallel compensation load. The virtually instantaneous manner in which the compensation load is turned back on to “replace” the deactivated device load, again, helps to avoid a fluctuation in the AC mains current. Once the device load is deactivated, the controller can initiate and manage a gradual ramping down of AC mains current (e.g., over several seconds) with a gradual decrease in the compensation load. The process of gradually ramping up and gradually ramping down the AC mains current in this manner can occur repeatedly with each cycle of activation and deactivation of a device load, thereby reducing fluctuations in the AC mains current and voltage that may otherwise violate IEC “flicker” regulatory standards.

In one example, a method of power management includes, prior to activating a device load, gradually increasing a compensation load in parallel with the device load to increase AC mains current to a current set point. The method includes activating the device load, and sensing the activation of the device load. Upon sensing activation of the device load, the compensation load is reduced to maintain the AC mains current at the current set point.

In another example, a power management system includes a device to implement a cyclical device load. The system includes a controller to increase AC mains current into the device to a current set point in anticipation of activating the device load. Increasing the AC mains current can be achieved by increasing a compensation load in parallel with the device load. A control loop in the power management system is to sense activation of the device load, and in response to the sensing, to turn off the compensation load to avoid an increase in the AC mains current beyond the current set point. In some examples, the control loop can sense a subsequent deactivation of the device load, and turn on the compensation load again to avoid a decrease in the AC mains current below the current set point. Thereafter, the controller can decrease the AC mains current into the device back down to a quiescent current level.

In another example, a non-transitory machine-readable storage medium stores instructions that when executed by a processor of a power management system causes the power management system to anticipate activating a device load, and prior to activating the device load, gradually increasing AC mains current through a compensation load in parallel with the device load. The instructions further cause the system to activate the device load after the AC mains current has reached a predetermined current set point, deactivate the device load, and then to gradually decrease the AC mains current through the compensation load from the current set point down to a quiescent current level.

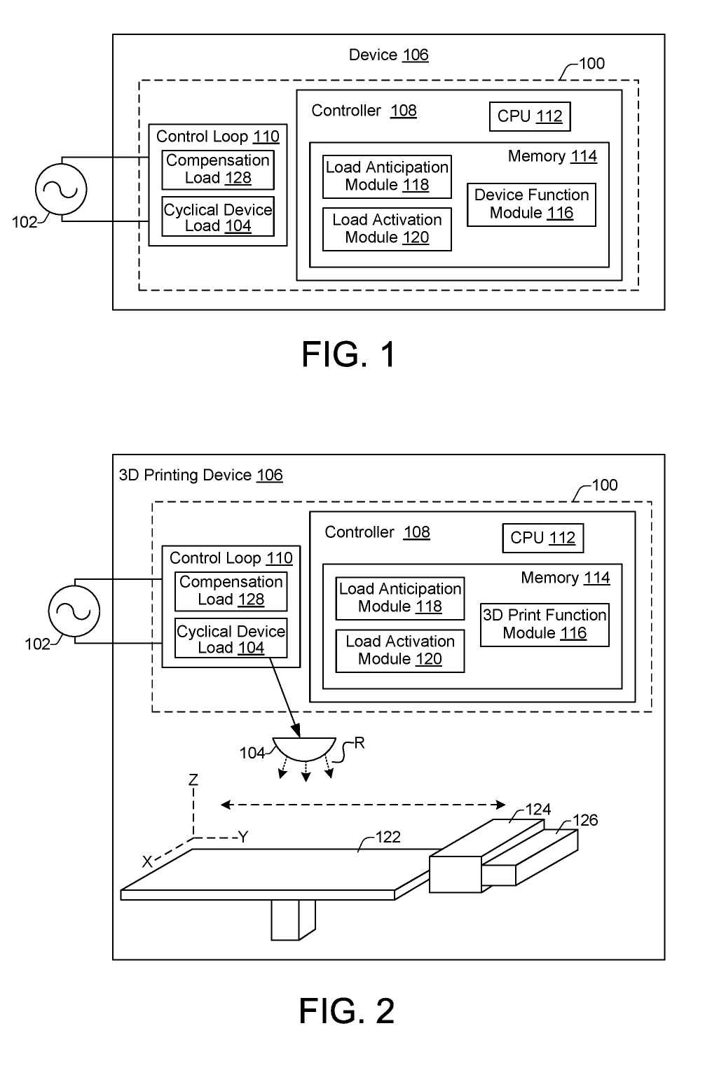

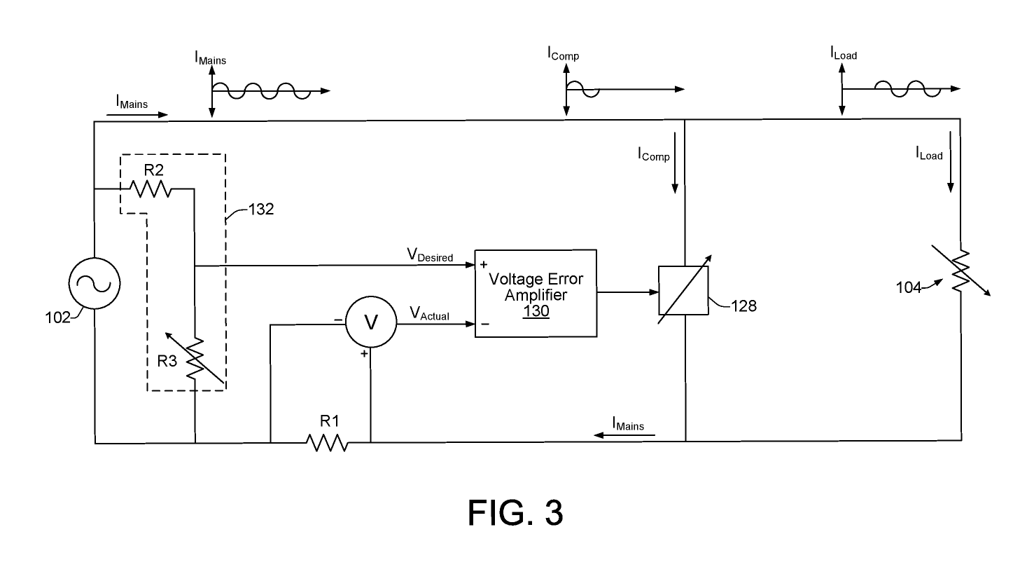

FIG. 1 shows a block diagram of an example of a power management system 100 suitable to reduce voltage fluctuations in an AC mains power supply 102. The power management system 100 can be implemented, for example, within devices that employ a cyclical device load 104, such as device 106. An example of a device 106 that implements a cyclical device load 104 includes a three-dimensional (3D) printing device 106, as shown in the block diagram of FIG. 2. While a device 106 is discussed herein as comprising a 3D printing device 106 implementing a cyclical device load 104, the power management system 100 is not limited to use in a 3D printing device 106 or other devices using cyclical device loads 104. Thus, a power management system 100 may be suitable for use in other types of devices implementing other types of loads.

Referring to FIGS. 1 and 2, an example power management system 100 can include a controller 108 and a control loop 110. The example controller 108 is suitable for controlling the 3D printing device 106 to implement layer by layer processing and generation of 3D parts. The controller 108 can additionally manage power fluctuations within the device 106 to avoid abrupt changes in current AC mains current from the AC mains power supply 102. An example controller 108 can include a processor (CPU) 112 and a memory 114, and in some cases may additionally include other electronics (not shown) for communicating with and controlling various components and functions of the 3D printing device 106. Such other electronics can include, for example, discrete electronic components and/or an ASIC (application specific integrated circuit).

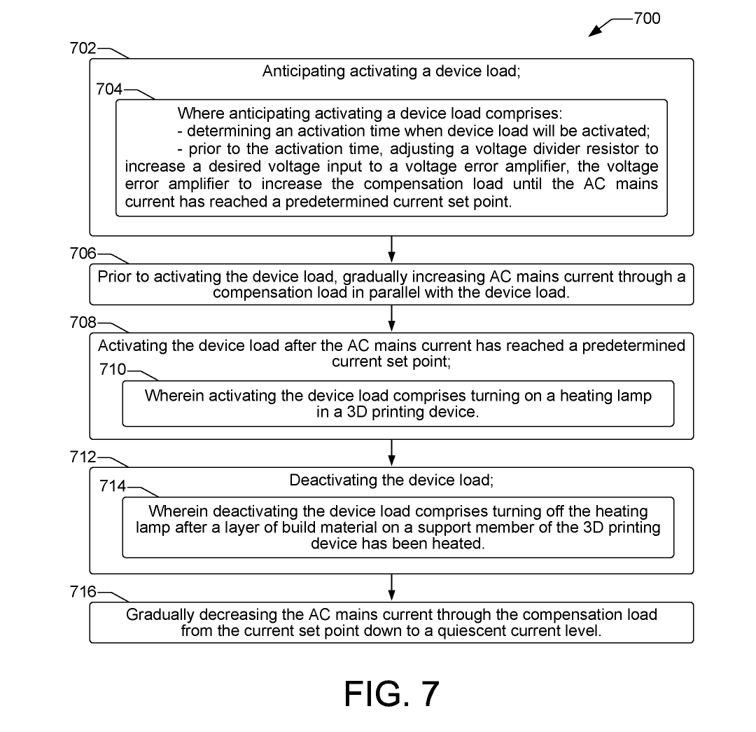

A memory 114 can include both volatile (i.e., RAM) and nonvolatile memory components (e.g., ROM, hard disk, optical disc, CD-ROM, magnetic tape, flash memory, etc.). The components of memory 114 comprise non-transitory, machine-readable (e.g., computer/processor-readable) media that can provide for the storage of machine-readable coded program instructions, data structures, program instruction modules, JDF (job definition format), and other data and/or instructions executable by a processor 112 of the 3D printing device 106. Examples of executable instructions to be stored in memory 114 include instructions associated with a device function module 116, a load anticipation module 118, and a load activation module 120. In general, modules 114, 116, and 118, include programming instructions and/or data executable by a processor 112 to cause the 3D printing device 106 to perform operations related to processing and generating 3D parts, and to control the power management system 100 to manage power fluctuations within the device 106 to avoid abrupt changes in AC mains current from the AC mains power supply 102. Such operations can include, for example, the operations of methods 600 and 700, described below with respect to FIGS. 6 and 7, respectively.

Referring still to FIGS. 1 and 2, components of an example 3D printing device 106 can include a support member 122 that functions as a fabrication bed to receive and hold build material for forming a 3D object. Build material can include, for example, materials such as powdered plastic and powdered metal. A material distributor 124 can provide a layer of build material onto the support member 122. Examples of a material distributor 124 can include a wiper blade, a roller, and combinations thereof. Build material can be supplied to the material distributor 124 from a hopper or other suitable delivery system. In the example 3D printing device 106 shown in FIG. 2, the material distributor 124 moves across the length of the support member 122 (along the Y axis) to deposit a layer of the build material. The support member 122 can move downward (along the Z axis) as additional layers of build material are deposited and processed.

An agent distributor 126 can deliver a fusing agent and/or a detailing agent in a selective manner onto portions of a layer of build material provided on support member 122. An agent distributor 126 can be implemented, for example, as one or multiple printheads, such as thermal inkjet printheads or piezoelectric inkjet printheads. As shown in FIG. 2, an example 3D printing device 106 can include a radiation source 104, or heat lamp 104, to emit radiation R to heat and melt layers of build material on the support member 122. When the heat lamp 104 is activated, it draws large amounts of current from the AC mains power supply 102 to enable it to generate enough heat to melt and fuse layers of build material.

The heat lamp 104 comprises a cyclical device load 104 that can be activated and deactivated within a single 3D printing process cycle to form a layer of a 3D part. For example, when forming a layer of a 3D part, the controller 108 can execute instructions from 3D print function module 116 to cause the material distributor 124 to deposit a layer of build material onto the support member 122. The controller 108 can additionally cause the agent distributor 126 to deliver a fusing agent onto portions of the layer of build material. Executing instructions from the load activation module 120, the controller 108 can activate and deactivate the heat lamp 104 at appropriate times within each process cycle to generate heat that can melt and solidify the layer. Thus, performing a single 3D printing process cycle comprises depositing and processing a single layer of build material in this general manner. Because the formation of a 3D part involves the processing of many layers, one after another, the heat lamp 104 behaves as a cyclical device load 104 that is activated and deactivate within each process cycle. The cyclical activation and deactivation of the large device load 104 can generate power fluctuations within the device 106 that cause current and voltage fluctuations (i.e., flicker) within the AC mains power supply 102.

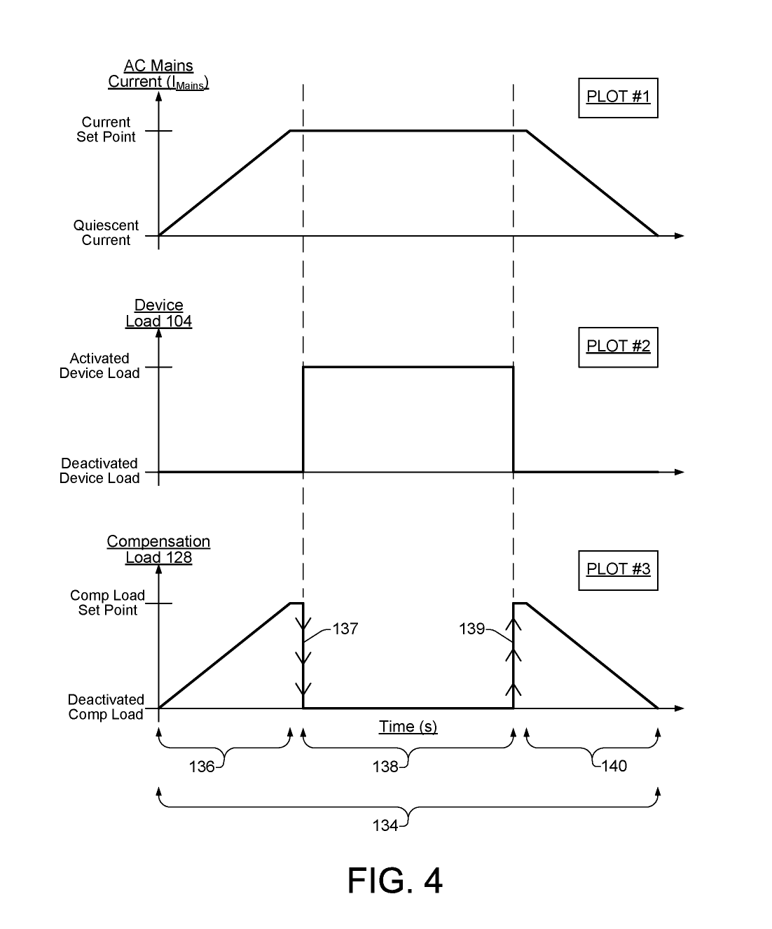

As noted above, an example power management system 100 can include a control loop 110. FIG. 3 shows a circuit diagram of an example of a control loop circuit 110. The control loop 110 can operate in conjunction with controller 108 to manage power fluctuations within the device 106 to avoid abrupt changes in AC mains current, I_{Mains}, from the AC mains power supply 102. As shown in FIG. 3, an example control loop 110 includes a compensation load 128 in parallel with the device load 104. The AC mains current, I_{Mains}, can be split between compensation current, I_{Comp}, through the compensation load 128, and device load current, I_{Load}, through the device load 104. The compensation load 128 is adjustable by a voltage error amplifier 130. The voltage error amplifier 130 amplifies the difference between a desired voltage, V_{Desired}, at a first input, and an actual voltage, V_{Actual}, at a second input. The value of V_{Desired} can be set by adjusting a voltage divider resistor, R3. The voltage divider 132 comprises resistors R2 and R3 in series across the AC mains power supply 102. The value of V_{Actual} is the voltage across a resistor R1 through which AC mains current, I_{Mains}, flows.

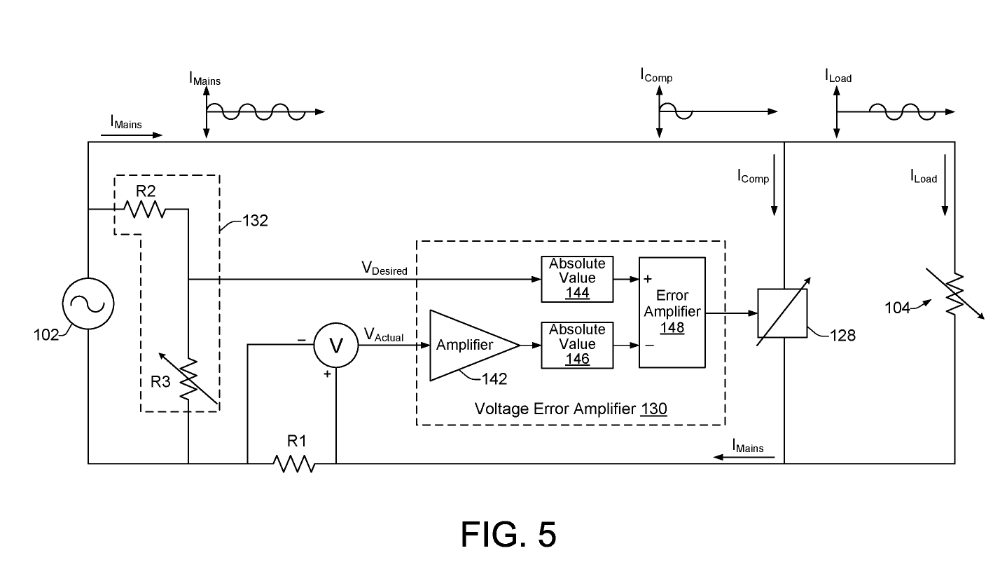

FIG. 4 shows example plots #1, #2, and #3, representing the behavior of the magnitude of the AC mains current, I_{Mains}, the device load 104, and the compensation load 128, during a time period encompassing part of a print process cycle 134 in which the device load 104 is activated and deactivated. Referring generally to FIGS. 1-4, during operation, a device 106 such as 3D printing device 106 can activate and deactivate a device load 104 in a cyclical manner, as discussed above. A controller 108 executing instructions from a load anticipation module 118 can anticipate when the device load 104 will be activated. As shown in FIG. 4, during a time period 136, the controller 108 can anticipate activating the device load 104 and gradually ramp up (i.e., increase) the AC mains current, I_{Mains}, to a predetermined current set point (Plot #1). In some examples, the time period 136 for gradually ramping up I_{Mains} can be on the order of 1 to 3 seconds in duration. In other examples, the time period 136 can be longer or shorter. The controller 108 increases AC mains current, I_{Mains}, by gradually increasing the value of resistor R3 in the voltage divider 132, shown in FIG. 3. Increasing R3 increases the voltage, V_{Desired}, at a first input of the voltage error amplifier 130. The voltage error amplifier 130 amplifies the difference between V_{Desired} and V_{Actual}, and it increases the compensation load 128 up to a compensation load set point (Plot #3, FIG. 4) over the time period 136, as V_{Desired} is increased. The increasing compensation load 128 increases the compensation current, I_{Comp}, and the AC mains current, I_{Mains}.

After the AC mains current, I_{Mains}, reaches the current set point, the controller 108 can activate the device load 104 (Plot #2, FIG. 4). Activation of the device load 104 causes an instant, but very short spike in the AC mains current, I_{Mains}, which causes a corresponding spike in the V_{Actual} voltage across R1. The voltage error amplifier 130 continues to amplify the difference between V_{Desired} and V_{Actual}, and instantly deactivates the compensation load 128 in response to the V_{Actual} voltage spike across R1. The activation of device load 104 and the virtually instantaneous deactivation of compensation load 128 causes the AC mains current, I_{Mains}, to remain unchanged and to flow through the device load 128 as I_{Load}. As shown in Plot #3 of FIG. 4, the instantaneous deactivation of the compensation load 128 can occur within a time period 137, whose duration is on the order of microseconds to milliseconds, which is shown as a straight line time period 137. The short duration of the spike in the AC mains current and V_{Actual} voltage upon activation of the device load 104 do not result in measurable Pst flicker in the AC mains power supply 102.

As shown in FIG. 4, the device load 104 can remain activated for a time period 138, after which the controller 108 can deactivate (e.g., turn off) the device load 104. In some examples, the time period 138 during which the device load 104 remains activated can be on the order of 3 to 7 seconds in duration. In other examples, the time period 138 can be longer or shorter. Deactivation of the device load 104 causes an instant drop in the AC mains current, I_{Mains}, which causes an instant drop in the V_{Actual} voltage across R1. The voltage error amplifier 130 continues to amplify the difference between V_{Desired} and V_{Actual}, and instantly activates the compensation load 128 in response to the V_{Actual} voltage drop across R1. As shown in Plot #3 of FIG. 4, the instantaneous activation of the compensation load 128 can occur within a time period 139, whose duration is on the order of microseconds to milliseconds, which is shown as a straight line time period 139. The short duration of the drop in the AC mains current and V_{Actual} voltage upon deactivation of the device load 104 do not result in measurable Pst flicker in the AC mains power supply 102. Thus, the deactivation of device load 104 and the virtually instantaneous reactivation of the compensation load 128 causes the AC mains current, I_{Mains}, to remain mostly constant and to flow back through the compensation load 128, as I_{Comp}.

After the controller 108 deactivates the device load 104, it can begin to gradually ramp down (i.e., decrease) the AC mains current, I_{Mains}, from the current set point to a quiescent current level as shown in Plot #1 of FIG. 4. In some examples, the time period 140 for gradually ramping down I_{Mains} can be on the order of 1 to 3 seconds in duration. In other examples, the time period 140 can be longer or shorter. The controller 108 decreases AC mains current, I_{Mains}, by gradually decreasing the value of resistor R3 in the voltage divider 132, shown in FIG. 3. Decreasing R3 decreases the voltage, V_{Desired}, at a first input of the voltage error amplifier 130. The voltage error amplifier 130 amplifies the difference between V_{Desired} and V_{Actual}, and decreases the compensation load 128 over the time period 140 (Plot #3) as V_{Desired} decreases. The decreasing compensation load 128 decreases the compensation current, I_{Comp}, and the AC mains current, I_{Mains}.

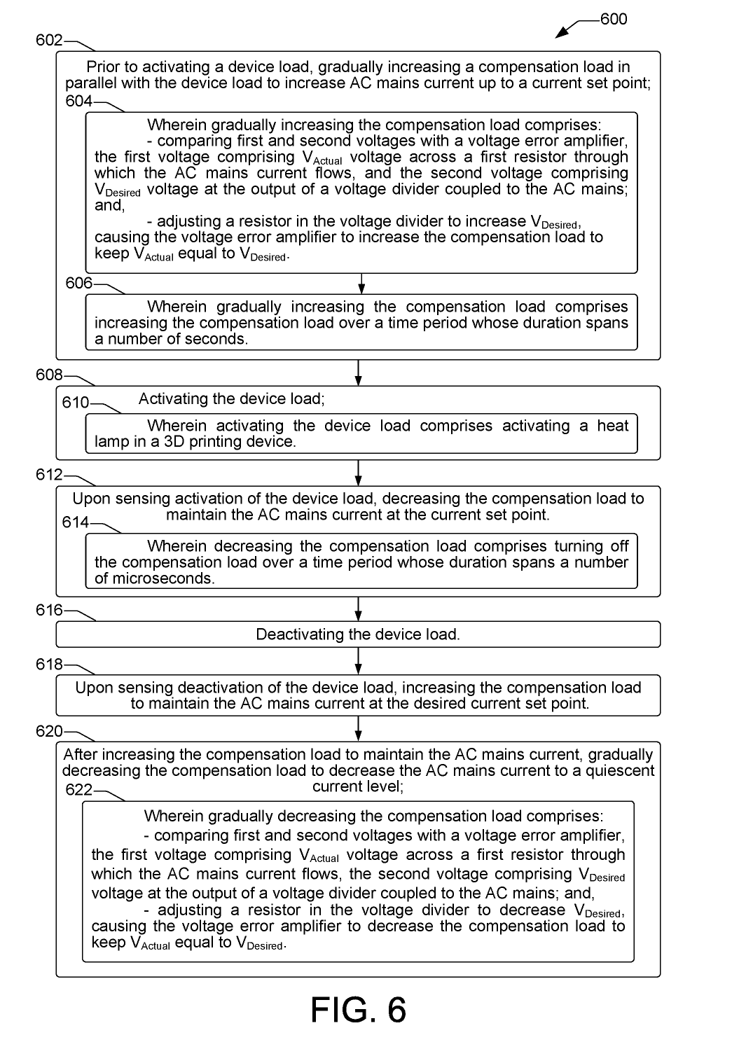

FIG. 5 shows a circuit diagram of an example of a control loop circuit 110, as in FIG. 3, with additional details of a voltage error amplifier 130. As shown in FIG. 5, a voltage error amplifier 130 can include an amplifier 142 to gain up the small V_{Actual} voltage signal across the resistor R1. The voltage error amplifier 130 additionally includes absolute value functions 144 and 146 to rectify, or demodulate, the V_{Desired} and V_{Actual} waveforms. An error amplifier 148 can amplify any difference between the demodulated waveforms, V_{Desired} and V_{Actual}, and modulate the value of the compensation load 128 up or down accordingly.

FIGS. 6 and 7 are flow diagrams showing example power management methods 600 and 700. Methods 600 and 700 are associated with examples discussed above with regard to FIGS. 1-5, and details of the operations shown in methods 600 and 700 can be found in the related discussion of such examples. The operations of methods 600 and 700 may be embodied as programming instructions stored on a non-transitory, machine-readable (e.g., computer/processor-readable) medium, such as memory 114 shown in FIGS. 1 and 2. In some examples, implementing the operations of methods 600 and 700 can be achieved by a processor, such as a processor 112 of FIGS. 1 and 2, reading and executing the programming instructions stored in a memory 114. In some examples, implementing the operations of methods 600 and 700 can be achieved using an ASIC and/or other hardware components alone or in combination with programming instructions executable by a processor 112.

The methods 600 and 700 may include more than one implementation, and different implementations of methods 600 and 700 may not employ every operation presented in the respective flow diagrams of FIGS. 6 and 7. Therefore, while the operations of methods 600 and 700 are presented in a particular order within their respective flow diagrams, the order of their presentations is not intended to be a limitation as to the order in which the operations may actually be implemented, or as to whether all of the operations may be implemented. For example, one implementation of method 600 might be achieved through the performance of a number of initial operations, without performing one or more subsequent operations, while another implementation of method 600 might be achieved through the performance of all of the operations.

Referring now to the flow diagram of FIG. 6, an example power management method 600 begins at block 602 with gradually increasing a compensation load in parallel with the device load to increase AC mains current up to a current set point. Gradually increasing the compensation load is to occur prior to activating a device load. As shown at block 604, in some examples gradually increasing the compensation load can include comparing first and second voltages with a voltage error amplifier, where the first voltage comprises a V_{Actual} voltage across a first resistor through which the AC mains current flows, and the second voltage comprises a V_{Desired} voltage at the output of a voltage divider coupled to the AC mains. Gradually increasing the compensation load can also include adjusting a resistor in the voltage divider to increase V_{Desired}, causing the voltage error amplifier to increase the compensation load to keep V_{Actual} equal to V_{Desired}. In some examples, as shown at block 606, gradually increasing the compensation load can include increasing the compensation load over a time period whose duration spans a number of seconds.

Continuing at block 608, the method 600 can include activating the device load. In some examples, activating the device load can include activating a heat lamp in a 3D printing device, as shown at block 610. As shown at block 612, upon sensing activation of the device load, the compensation load can be decreased to maintain the AC mains current at the current set point. Decreasing the compensation load can include turning off the compensation load over a time period whose duration spans a number of microseconds, as shown at block 614. The method can continue at block 616, with deactivating the device load. As shown at block 618, upon sensing deactivation of the device load, the compensation load can be increased to maintain the AC mains current at the desired current set point.

After increasing the compensation load to maintain the AC mains current, the method can include gradually decreasing the compensation load to decrease the AC mains current to a quiescent current level, as shown at block 620. In some examples, as shown at block 622, gradually decreasing the compensation load can include comparing first and second voltages with a voltage error amplifier, where the first voltage comprise a V_{Actual} voltage across a first resistor through which the AC mains current flows, and the second voltage comprises a V_{Desired} voltage at the output of a voltage divider coupled to the AC mains. Gradually decreasing the compensation load can also include adjusting a resistor in the voltage divider to decrease V_{Desired}, causing the voltage error amplifier to decrease the compensation load to keep V_{Actual} equal to V_{Desired}.

Referring now to the flow diagram of FIG. 7, another example power management method 700 begins at block 702 with anticipating activating a device load. In some examples, as shown at block 704, anticipating activating a device load can include determining an activation time when the device load will be activated, and prior to the activation time, adjusting a voltage divider resistor to increase a desired voltage input to a voltage error amplifier, where the voltage error amplifier is to increase the compensation load until the AC mains current has reached a predetermined current set point.

The method can continue as shown at block 706, with gradually increasing AC mains current through a compensation load in parallel with the device load, prior to activating the device load. As shown at block 708, the method can include activating the device load after the AC mains current has reached a predetermined current set point. In some examples, activating the device load can include turning on a heating lamp in a 3D printing device, as shown at block 710. The method can further include deactivating the device load, as shown at block 712, where the deactivating of the device load includes turning off the heating lamp after a layer of build material on a support member of the 3D printing device has been heated, as shown at block 714. As shown at block 716, the method can also include gradually decreasing the AC mains current through the compensation load from the current set point down to a quiescent current level.

What is claimed is:

1. A method of power management, comprising:
prior to activating a device load, gradually increasing a compensation load in parallel with the device load to increase AC mains current up to a current set point;
activating the device load;
upon sensing activation of the device load, decreasing the compensation load to maintain the AC mains current at the current set point.

2. A method as in claim 1, further comprising:
deactivating the device load;
upon sensing deactivation of the device load, increasing the compensation load to maintain the AC mains current at the desired current set point.

3. A method as in claim 2, further comprising:
after increasing the compensation load to maintain the AC mains current, gradually decreasing the compensation load to decrease the AC mains current to a quiescent current level.

4. A method as in claim 1, wherein gradually increasing the compensation load comprises:
comparing first and second voltages with a voltage error amplifier, the first voltage comprising V_{Actual} voltage across a first resistor through which the AC mains current flows, and the second voltage comprising V_{Desired} voltage at the output of a voltage divider coupled to the AC mains; and,
adjusting a resistor in the voltage divider to increase V_{Desired}, causing the voltage error amplifier to increase the compensation load to keep V_{Actual} equal to V_{Desired}.

5. A method as in claim 3, wherein gradually decreasing the compensation load comprises:
comparing first and second voltages with a voltage error amplifier, the first voltage comprising V_{Actual} voltage across a first resistor through which the AC mains current flows, and the second voltage comprising V_{Desired} voltage at the output of a voltage divider coupled to the AC mains; and,
adjusting a resistor in the voltage divider to decrease V_{Desired}, causing the voltage error amplifier to decrease the compensation load to keep V_{Actual} equal to V_{Desired}.

6. A method as in claim 1, wherein:
gradually increasing the compensation load comprises increasing the compensation load over a time period whose duration spans a number of seconds; and,
decreasing the compensation load comprises turning off the compensation load over a time period whose duration spans a number of microseconds.

7. A method as in claim 1, wherein activating the device load comprises activating a heat lamp in a 3D printing device.

8. A power management system comprising:
a device to implement a cyclical device load;
a controller to anticipate activating the device load by increasing AC mains current into the device up to a current set point by increasing a compensation load in parallel with the device load; and,
a control loop to sense activation of the device load, and in response to the sensing, to turn off the compensation load to avoid an increase in the AC mains current beyond the current set point.

9. A system as in claim 8, wherein the device comprises a 3D printing device, and the device load comprises a heating lamp in the 3D printing device.

10. A system as in claim 8, wherein the control loop comprises:
voltage error amplifier to amplify a difference between an actual voltage of an AC mains power supply and a desired voltage of the AC mains power supply, and to drive the compensation load up or down according to the difference.

11. A system as in claim 10, wherein the voltage error amplifier comprises:
a first absolute value function to demodulate a waveform of the actual voltage;
a second absolute value function to demodulate a waveform of the desired voltage; and,
an error amplifier to amplify a difference between the demodulated waveforms.

12. A non-transitory machine-readable storage medium storing instructions that when executed by a processor of a power management system cause the power management system to:
anticipate activating a device load;
prior to activating the device load, gradually increase AC mains current through a compensation load in parallel with the device load;
activate the device load after the AC mains current has reached a predetermined current set point;
deactivate the device load; and,
gradually decrease the AC mains current through the compensation load from the current set point down to a quiescent current level.

13. A medium as in claim 12, wherein anticipating activating a device load comprises:
determining an activation time when the device load will be activated; and
prior to the activation time, adjusting a voltage divider resistor to increase a desired voltage input to a voltage error amplifier, the voltage error amplifier to increase the compensation load until the AC mains current has reached a predetermined current set point.

14. A medium as in claim 12, wherein:
activating the device load comprises turning on a heating lamp in a 3D printing device; and,
deactivating the device load comprises turning off the heating lamp after a layer of build material on a support member of the 3D printing device has been heated.

15. A medium as in claim 12, wherein gradually increasing AC mains current and gradually decreasing the AC mains current comprise increasing and decreasing the AC mains current, respectively, over a time period spanning a number of seconds.
